(19) United States
(12) Patent Application Publication
(10) Pub. No.: US 2023/0351706 A1
(43) Pub. Date: Nov. 2, 2023

(54) SCANNING INTERFACE SYSTEMS AND METHODS FOR BUILDING A VIRTUAL REPRESENTATION OF A LOCATION

(71) Applicant: YEMBO, INC., San Diego, CA (US)

(72) Inventors: Kyle BABINOWICH, San Diego, CA (US); Marc EDER, San Diego, CA (US); Marguerite SHUSTER, San Diego, CA (US); Zachary RATTNER, San Diego, CA (US)

(21) Appl. No.: 18/131,811

(22) Filed: Apr. 6, 2023

Related U.S. Application Data
(60) Provisional application No. 63/335,335, filed on Apr. 27, 2022.

(51) Int. Cl. G06T 19/00; G01C 21/36

(52) U.S. Cl. CPC G06T 19/006; G01C 21/3629

(57) ABSTRACT

A user interface comprises an augmented reality (AR) overlay on top of a live camera feed that facilitates positioning guidance information in real-time in a location being scanned. A guide is provided and moves (and/or causes the user to move a scan) through a scene during scanning such that a user can follow the guide, and conformance to the guide can be tracked during the scanning to determine if a scanning motion is within requirements. This reduces a cognitive load on the user required to obtain a scan because the user is simply following the guide. Real-time feedback depending on the user's adherence or lack of conformance to guided movements is provided to the user. The guide is configured to follow a pre-planned route, or a route determined in real-time during the scan.

### CROSS REFERENCE TO RELATED APPLICATIONS

This application is based on, and claims the benefit of priority to, provisional application No. 63/335,335, filed Apr. 27, 2022, the entire contents of which are incorporated herein by reference. This application builds on earlier filed U.S. patent application Ser. No. 17/194,075, titled “Systems and Methods for Building a Virtual Representation of a Location”, which is hereby incorporated by reference in its entirety. The present disclosure focuses on an electronic scanning interface that is run as an electronic application (app) on a smartphone or other computing device that a user physically in a location uses to build a virtual three dimensional (3D) representation of the location.

### FIELD OF THE DISCLOSURE

This disclosure relates to scanning interface systems and methods for obtaining information about a location, and providing artificial intelligence based virtual representations of the location enriched with spatially localized details, based on the obtained information.

### BACKGROUND

Myriad tasks for home services revolve around an accurate 3-dimensional spatial and semantic understanding of a location such as a home. For example, estimating repair costs or planning renovations requires understanding the current state of the home. Filing an insurance claim requires accurate documentation and measurements of damages. Moving into a new home requires a reliable estimate as to whether one's belongings and furniture will fit. Currently, the best ways to achieve the requisite 3-dimensional spatial and semantic understanding involves manual measurements, hard-to-acquire architectural drawings, and arrangements with multiple parties with competing schedules and interests.

A simplified and more user friendly system for capturing images and videos of a location, and generating accurate virtual representations based on the captured images and videos is needed. For example, a system for intuitively obtaining images, videos, and/or other information about a location is desired. Further, a system that can use the images and videos to automatically generate virtual representations based on intuitively obtained information is desired.

### SUMMARY

Systems, methods, and computer program products for generating a three dimensional (3D) virtual representation of a location with spatially localized information of elements within the location being embedded in the 3D virtual representation are described. Description data from a scanning of a location is received. The description data is generated via a camera and a user interface and/or other components. The description data comprises a plurality of images and/or video. The user interface comprises an augmented reality (AR) overlay on top of a live camera feed that facilitates positioning guidance information in real-time in the location being scanned. Image frames being collected from the camera are recorded, but not AR overlay information, such that a resulting 3D virtual representation of the location is generated from image frames from the camera, and the AR overlay is used guide the user but is not needed after capture is complete. An AR guide is provided on top of the live camera feed and moves (and/or causes the user to move) through a scene during the scanning such that a user can follow the guide, and conformance to the guide can be tracked during the scanning to determine if a scanning motion is within requirements. This reduces a cognitive load on the user required to obtain a scan because the user is simply following the guide, instead of remembering a list of scanning rules, for example. Real-time feedback depending on the user's adherence or lack of conformance to guided movements is provided to the user. The guide is configured to follow a pre-planned route, or a route determined in real-time during the scan. The 3D virtual representation of the location is generated and annotated with spatially localized metadata associated with the elements within the location, and semantic information of the elements within the location. The 3D virtual representation is editable by a user to allow modifications to the spatially localized metadata.

Systems, methods, and computer program products are disclosed that include receiving data of a location in the form of images and/or a video feed, for example, from a client device configured to be controlled by a user. The received data serves as an input to a model (e.g., an artificial intelligence (AI)-based model such as a machine learning model) configured to generate the 3D virtual representation of the location enriched with spatially localized details about elements of the location. The 3D virtual representation can be used for various purposes.

The present disclosure provides a system that resolves several impediments in existing 3-dimensional visualization systems by creating a 3D virtual representation of a location, and enabling this representation to be a platform for collaborative interaction for services and/or tasks to be performed by a user. The 3D virtual representation includes a 3D model of the location that is appropriately textured to match the corresponding location, annotated to describe elements of the location on the 3D model, and associated with metadata such as audio, visual, geometric, and natural language media that can be spatially localized within the context of the 3D model. Furthermore, comments and notes may also be associated with the 3D model of the location. The system enables multiple users to synchronously or asynchronously utilize the virtual representation to collaboratively inspect, review, mark up, augment, and otherwise analyze the location entirely through one or more electronic devices (e.g., a computer, a phone, a tablet, etc.) in order to perform desired services and/or tasks at the location.

Existing capture processes can be tedious and unintuitive. Existing automated solutions for constructing a 3D model often ask users to take panoramic data (e.g., in the form of images or a video) with strong constraints or rules as to how much a camera is allowed to move and where a user should stand. The present systems, methods, and computer program products simplify the capture process for a user, among other advantages.

Accordingly, a method for generating a three dimensional (3D) virtual representation of a location with spatially localized information of elements within the location being embedded in the 3D virtual representation is provided. The method comprises generating a user interface that includes an augmented reality (AR) overlay on top of a live camera feed. This facilitates positioning guidance information for a user controlling the camera feed in real-time for a scene at the location being scanned. The method comprises providing a guide with the AR overlay that moves through the scene at the location during scanning such that the user can follow the guide, and conformance to the guide can be tracked during the scanning to determine if a scanning motion by the user is within requirements, and such that a cognitive load on the user required to obtain a scan is reduced because the user is following the guide. Real-time feedback is provided to the user via the guide depending on a user adherence or lack of conformance to guide movements. The method comprises capturing description data of the location. The description data is generated via the camera and the user interface. The description data comprises a plurality of images and/or video of the location in the live camera feed. The method comprises recording image frames from the plurality of images and/or video being collected from the camera, but not the AR overlay, such that the 3D virtual representation of the location is generated from the image frames from the camera, and the AR overlay is used to guide the user with the positioning guidance information, but is not needed after capture is complete. The method comprises annotating the 3D virtual representation of the location with spatially localized metadata associated with the elements within the location, and semantic information of the elements within the location. The 3D virtual representation is editable by the user to allow modifications to the spatially localized metadata.

In some embodiments, the guide comprises a moving marker including one or more of a dot, a ball, or a cartoon, and indicates a trajectory. The moving marker and the trajectory are configured to cause the user to move the camera throughout the scene at the location.

In some embodiments, the guide comprises a series of tiles configured to cause the user to follow motions indicated by the series of tiles with the camera throughout the scene at the location.

In some embodiments, the guide is configured to follow a pre-planned route through the scene at the location. In some embodiments, the guide is configured to follow a route through the scene at the location determined in real-time during the scan.

In some embodiments, the guide causes rotational and translational motion by the user. In some embodiments, the guide causes the user to scan areas of the scene at the location directly above and directly below the user.

In some embodiments, the method comprises, prior to providing the guide with the AR overlay that moves through the scene at the location, causing the AR overlay to use the user interface to make the user indicate a location of a floor, wall, and/or ceiling in the camera feed, and then providing the guide with the AR overlay that moves through the scene at the location based on the location of the floor, wall, and/or ceiling. In some embodiments, the method automatically detecting a location of a floor, wall, and/or ceiling in the camera feed, and providing the guide with the AR overlay that moves through the scene at the location based on the location of the floor, wall, and/or ceiling.

In some embodiments, the method comprises providing a bounding box with the AR overlay configured to be manipulated by the user via the user interface to indicate the location of one or more of a floor, a wall, a ceiling, and/or an object in the scene at the location, and providing the guide with the AR overlay that moves through the scene at the location based on the bounding box.

In some embodiments, the guide comprises a real-time feedback indicator that shows an affirmative state if a user's position and/or motion is within allowed thresholds, or correction information if the user's position and/or motion breaches the allowed thresholds during the scan.

In some embodiments, the AR overlay further comprises: a mini map showing where a user is located in the scene at the location relative to a guided location; a speedometer showing a user's scan speed with the camera relative to minimum and/or maximum scan speed thresholds, and/or an associated warning; an indicator that informs the user whether illumination at the location is sufficient for the scan, and/or an associated warning; and/or horizontal and/or vertical plane indicators.

In some embodiments, the method comprises generating, in real-time, via a machine learning model and/or a geometric model, the 3D virtual representation of the location and elements therein. The machine learning model and/or the geometric model are configured to receive the plurality of images and/or video, along with pose matrices, as inputs, and predict geometry of the location and the elements therein to form the 3D virtual representation.

In some embodiments, generating the 3D virtual representation comprises: encoding each image of the plurality of images and/or video with the machine learning model; adjusting, based on the encoded images of the plurality of images, an intrinsics matrix associated with the camera; using the intrinsics matrix and pose matrices to back-project the encoded images into a predefined voxel grid volume; and providing the voxel grid as input to a neural network to predict a 3D model of the location for each voxel in the voxel grid.

In some embodiments, the intrinsics matrix represents physical attributes of a camera, the physical attributes comprising: focal length, principal point, and skew. In some embodiments, a pose matrix represents a relative or absolute orientation of the camera in a virtual world. The pose matrix comprises 3-degrees-of-freedom rotation of the camera and a 3-degrees-of-freedom position in a virtual representation.

In some embodiments, annotating the 3D virtual representation with spatially localized metadata comprises spatially localizing the metadata using a geometric estimation model, or manual entry of the metadata via the user interface. Spatially localizing of the metadata comprises: receiving additional images of the location and associating the additional images to the 3D virtual representation of the location; computing camera poses associated with the additional images with respect to the plurality of images and/or video and the 3D virtual representation; and relocalizing, via the geometric estimation model and the camera poses, the additional images and associating metadata.

In some embodiments, metadata associated with an element comprises at least one of: geometric properties of the element; material specifications of the element; a condition of the element; receipts related to the element; invoices related to the element; spatial measurements captured through the 3D virtual representation or physically at the location; audio, visual, or natural language notes; or 3D shapes and objects including geometric primitives and CAD models.

In some embodiments, annotating the 3D virtual representation with the semantic information comprises identifying elements from the plurality of images, the video, and/or the 3D virtual representation by a semantically trained machine learning model. The semantically trained machine learning model is configured to perform semantic or instance segmentation and 3D object detection and localization of each object in an input image.

In some embodiments, the description data comprises one or more media types. The media types comprise at least one or more of video data, image data, audio data, text data, user interface/display data, and/or sensor data.

In some embodiments, capturing description data comprises receiving sensor data from one or more environment sensors. The one or more environment sensors comprise at least one of a GPS, an accelerometer, a gyroscope, a barometer, magnetometer, or a microphone.

In some embodiments, the description data is captured by a mobile computing device associated with a user and transmitted to one or more processors of the mobile computing device and/or an external server with or without user interaction.

In some embodiments, the method comprises generating, in real-time, the 3D virtual representation by: receiving, at a user device, the description data of the location, transmitting the description data to a server configured to execute the machine learning model to generate the 3D virtual representation of the location, generating, at the server based on the machine learning model and the description data, the 3D virtual representation of the location, and transmitting the 3D virtual representation to the user device.

In some embodiments, the method comprises estimating pose matrices and intrinsics for each image of the plurality of images and/or video by a geometric reconstruction framework configured to triangulate 3D points based on the plurality of images and/or video to estimate both camera poses up to scale and camera intrinsics, and inputting the pose matrices and intrinsics to a machine learning model to accurately predict the 3D virtual representation of the location.

In some embodiments, the geometric reconstruction framework comprises at least one of: structure-from-motion (SFM), multi-view stereo (MVS), or simultaneous localization and mapping (SLAM).

In some embodiments, there is provided a non-transitory machine-readable medium storing instructions which, when executed by at least one programmable processor, cause the at least one programmable processor to perform any of the operations described above.

Implementations of the current subject matter can include, but are not limited to, methods consistent with the descriptions provided herein as well as articles that comprise a tangibly embodied machine-readable medium (e.g., a non-transitory computer readable medium) operable to cause one or more machines (e.g., computers, etc.) to perform operations implementing one or more of the described features. Similarly, computer systems are also contemplated that may include one or more processors, and one or more memory modules coupled to the one or more processors. A memory module, which can include a computer-readable storage medium, may include, encode, store, or the like, one or more programs that cause one or more processors to perform one or more of the operations described herein. Computer implemented methods consistent with one or more implementations of the current subject matter can be implemented by one or more data processors residing in a single computing system, or across multiple computing systems. Such multiple computing systems can be connected and can exchange data and/or commands or other instructions, or the like via one or more connections, including, but not limited, to a connection over a network (e.g., the internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to particular implementations, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations.

FIG. 1 illustrates a system for generating a three dimensional (3D) virtual representation of a location with spatially localized information of elements within the location being embedded in the 3D virtual representation, according to an embodiment.

FIG. 2 illustrates a user interface that comprises an augmented reality (AR) overlay on top of a live camera feed, with a guide comprising a cartoon in this example, according to an embodiment.

FIG. 3 illustrates an example of a guide that comprises a series of tiles, according to an embodiment.

FIG. 4 illustrates example components of an AR overlay comprising a mini map showing where a user is located in the scene at the location relative to a guided location; and a speedometer showing a user's scan speed with the camera relative to minimum and/or maximum scan speed thresholds, according to an embodiment.

FIG. 5 illustrates different example views of three different example user interfaces showing a user interface causing the user to indicate a location of on a floor at a corner with a wall and a door, automatically detecting a location of a floor, and a user interface in the process of automatically detecting (the dot in the interface is moving up the wall toward the ceiling) the location of a ceiling in a camera feed, according to an embodiment.

FIG. 6 is a diagram that illustrates an exemplary computer system, according to an embodiment.

FIG. 7 is a flowchart of a method for generating a three dimensional (3D) virtual representation of a location with spatially localized information of elements within the location being embedded in the 3D virtual representation is provided, including generating a user interface that includes an augmented reality (AR) overlay on top of a live camera feed, according to an embodiment.

### DETAILED DESCRIPTION

Current methods for building virtual representations of locations involve scanning a scene (e.g., a room) at a location (e.g., a house), and building a virtual representation (e.g., 3D virtual representation) that can be used to generate measurements, identify contents, and other workflows that are useful in moving, home improvement and/or repair, property insurance, and/or other scenarios. A location can be any open or closed space for which a 3D virtual representation may be generated. For example, the location may be a physical (e.g., outdoor) area, a room, a house a warehouse, a classroom, an office space, an office room, a restaurant room, a coffee shop, etc.

Until now, in order to generate a 3D virtual representation with a measurement scale (e.g., so measurements can easily and accurately be taken), there were often several conditions or rules under which a user had to follow when scanning a room (e.g., a scene at a location). These conditions or rules often included things like, for example: the user should stand about five feet away from a wall; the user should face the wall; the user should tilt the phone (or other computing device) up and down to include both the ceiling and the floor in the scan; the user should walk around the room, always facing the wall until they complete their way around the room; translational motion is preferable to rotational motion; after completing the circuit, the user should include the center of the room in the scan; etc.

In addition to the existence of these kinds of conditions or rules, a user also is generally untrained for many use cases. For example, a homeowner filing a damage claim for insurance purposes is likely not familiar with the reconstruction process, and so may not even know where to scan, what features of a scene at a location are important to scan, etc.

As an example, assuming a user knows where to scan, and after performing a scan properly (e.g., according to one or more of the example rules described above), an accurate floor plan may be generated. However, a user may scan in the wrong place, or miss an important part of a room when scanning. Even if the user scans in the correct areas, if scanned improperly (e.g., outside of one or more of the example rules described above), the amount of error varies, and the resulting scan may be unusable for moving, home improvement and/or repair, property insurance, and/or other purposes.

Advantageously, the present systems, methods, and computer program products provide a scan user interface that guides the user to scan an appropriate location, and move in an appropriate way as the user scans. The user interface guides a user to conduct a scan according to one or more of the example rules described above, without the user needed to be conscious of all of those rules while they scan. The user interface is intuitive, even though the motion requirements (e.g., conditions or rules described above) may be extensive.

Among other functionality, the present systems, methods, and computer program products provide an augmented reality (AR) overlay on top of a live camera feed that allows for positioning guidance information in real-time in the physical location being scanned. Images and/or video frames being collected from the camera are recorded, but not the AR overlay information, such that a resulting 3D virtual representation is generated from video frames from the camera (e.g., the AR overlay guides the user but is not needed after the capture is complete. An AR guide is provided that moves through a scene (and/or otherwise causes the user to move the camera through or around the scene). The user can follow the guide. Conformance to the guide is tracked to determine if the motion is within requirements, for example. This effectively simplifies the cognitive load required to take a good scan because the user is just following the guide marker, as opposed to remembering a list of rules. Real-time feedback depending on the user's adherence or lack of conformance to the guided movements is provided. The guide can follow a pre-planned route, or a route determined in real-time during the scan.

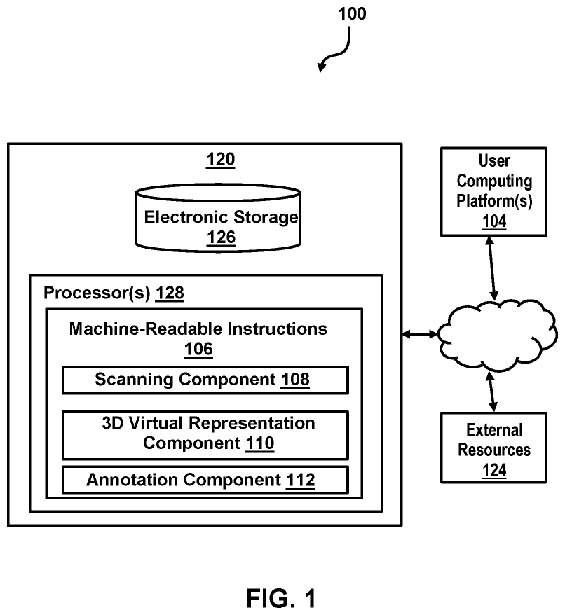

FIG. 1 illustrates a system 100 configured for generating a three dimensional (3D) virtual representation of a location with spatially localized information of elements within the location being embedded in the 3D virtual representation, according to an embodiment. As described herein, system 100 is configured to provide a user interface via user computer platform(s) 104 (e.g., which may include a smartphone and/or other user comping platforms) including an augmented reality (AR) overlay on top of a live camera feed that facilitates positioning guidance information for a user in real-time in a location being scanned. System 100 is configured such that a guide is provided and moves (and/or causes the user to move a scan) through a scene during scanning such that a user can follow the guide, and conformance to the guide can be tracked during the scanning to determine if a scanning motion is within requirements. This reduces a cognitive load on the user required to obtain a scan because the user is simply following the guide. Real-time feedback depending on the user's adherence or lack of conformance to guided movements is provided to the user.

In some embodiments, system 100 may include one or more servers 102. The server(s) 102 may be configured to communicate with one or more user computing platforms 104 according to a client/server architecture. The users may access system 100 via user computing platform(s) 104.

The server(s) 102 and/or computing platform(s) 104 may include one or more processors 128 configured to execute machine-readable instructions 106. The machine-readable instructions 106 may include one or more of a scanning component 108, a 3D virtual representation component 110, an annotation component 112 and/or other components. In some embodiments, some or all of processors 128 and/or the components may be located in computing platform(s) 104, the cloud, and/or other locations. Processing may be performed in one or more of server 102, a user computing platform 104 such as a mobile device, the cloud, and/or other devices.

In some embodiments, system 100 and/or server 102 may include an application program interface (API) server, a web server, electronic storage, a cache server, and/or other components. These components, in some embodiments, communicate with one another in order to provide the functionality of system 100 described herein.

The cache server may expedite access to description data (as described herein) and/or other data by storing likely relevant data in relatively high-speed memory, for example, in random-access memory or a solid-state drive. The web server may serve webpages having graphical user interfaces that display one or more views that facilitate obtaining the description data (via the AR overlay described below), and/or other views. The API server may serve data to various applications that process data related to obtained description data, or other data. The operation of these components may be coordinated by processor(s) 128, which may bidirectionally communicate with each of these components or direct the components to communicate with one another. Communication may occur by transmitting data between separate computing devices (e.g., via transmission control protocol/internet protocol (TCP/IP) communication over a network), by transmitting data between separate applications or processes on one computing device; or by passing values to and from functions, modules, or objects within an application or process, e.g., by reference or by value.

In some embodiments, interaction with users and/or other entities may occur via a website or a native application viewed on a user computing platform 104 such as a smartphone, a desktop computer, tablet, or a laptop of the user. In some embodiments, such interaction occurs via a mobile website viewed on a smartphone, tablet, or other mobile user device, or via a special-purpose native application executing on a smartphone, tablet, or other mobile user device. Data (e.g., description data) may be extracted, stored, and/or transmitted by processor(s) 128 and/or other components of system 100 in a secure and encrypted fashion. Data extraction, storage, and/or transmission by processor(s) 128 may be configured to be sufficient for system 100 to function as described herein, without compromising privacy and/or other requirements associated with a data source. Facilitating secure description data transmissions across a variety of devices is expected to make it easier for the users to complete 3D virtual representation generation when and where convenient for the user, and/or have other advantageous effects.

To illustrate an example of the environment in which system 100 operates, the illustrated embodiment of FIG. 1 includes a number of components which may communicate: user computing platform(s) 104, server 102, and external resources 124. Each of these devices communicates with each other via a network (indicated by the cloud shape), such as the Internet or the Internet in combination with various other networks, like local area networks, cellular networks, Wi-Fi networks, or personal area networks.

User computing platform(s) 104 may be smartphones, tablets, gaming devices, or other hand-held networked computing devices having a display, a user input device (e.g., buttons, keys, voice recognition, or a single or multi-touch touchscreen), memory (such as a tangible, machine-readable, non-transitory memory), a network interface, a portable energy source (e.g., a battery), a camera, one or more sensors (e.g., an accelerometer, a gyroscope, a depth sensor, etc.), a speaker, a microphone, a processor (a term which, as used herein, includes one or more processors) coupled to each of these components, and/or other components. The memory of these devices may store instructions that when executed by the associated processor provide an operating system and various applications, including a web browser and/or a native mobile application configured for the operations described herein.

A native application and/or a web browser, in some embodiments, are operative to provide a graphical user interface associated with a user, for example, that communicates with server 102 and facilitates user interaction with data from a user computing platform 104, server 102, and/or external resources 124. In some embodiments, processor(s) 128 may reside on sever 102, user computing platform(s) 104, servers external to system 100, and/or in other locations. In some embodiments, processor(s) 128 may run an application on sever 102, a user computing platform 104, and/or other devices.

In some embodiments, a web browser may be configured to receive a website from server 102 having data related to instructions (for example, instructions expressed in JavaScript™) that when executed by the browser (which is executed by a processor) cause a user computing platform 104 to communicate with server 102 and facilitate user interaction with data from server 102.

A native application and/or a web browser, upon rendering a webpage and/or a graphical user interface from server 102, may generally be referred to as client applications of server 102. Embodiments, however, are not limited to client/server architectures, and server 102, as illustrated, may include a variety of components other than those functioning primarily as a server. Only one user computing platform 104 is shown, but embodiments are expected to interface with substantially more, with more than 100 concurrent sessions and serving more than 1 million users distributed over a relatively large geographic area, such as a state, the entire United States, and/or multiple countries across the world.

External resources 124, in some embodiments, include sources of information such as databases, websites, etc.; external entities participating with system 100 (e.g., systems or networks associated with home services providers, associated databases, etc.), one or more servers outside of the system 100, a network (e.g., the internet), electronic storage, equipment related to Wi-Fi™ technology, equipment related to Bluetooth® technology, data entry devices, or other resources. In some implementations, some or all of the functionality attributed herein to external resources 124 may be provided by resources included in system 100. External resources 124 may be configured to communicate with server 102, user computing platform(s) 104, and/or other components of system 100 via wired and/or wireless connections, via a network (e.g., a local area network and/or the internet), via cellular technology, via Wi-Fi technology, and/or via other resources.

Electronic storage 126, in some embodiments, stores and/or is configured to access data from a user computing platform 104, data generated by processor(s) 128, and/or other information. Electronic storage 126 may include various types of data stores, including relational or non-relational databases, document collections, and/or memory images and/or videos, for example. Such components may be formed in a single database, or may be stored in separate data structures. In some embodiments, electronic storage 126 comprises electronic storage media that electronically stores information. The electronic storage media of electronic storage 126 may include one or both of system storage that is provided integrally (i.e., substantially non-removable) with system 100 and/or other storage that is connectable (wirelessly or via a wired connection) to system 100 via, for example, a port (e.g., a USB port, a firewire port, etc.), a drive (e.g., a disk drive, etc.), a network (e.g., the Internet, etc.). Electronic storage 126 may be (in whole or in part) a separate component within system 100, or electronic storage 126 may be provided (in whole or in part) integrally with one or more other components of system 100 (e.g., in server 102). In some embodiments, electronic storage 126 may be located in a data center (e.g., a data center associated with a user), in a server that is part of external resources 124, in a user computing platform 104, and/or in other locations. Electronic storage 126 may include one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), or other electronically readable storage media. Electronic storage 126 may store software algorithms, information determined by processor(s) 128, information received via the graphical user interface displayed on a user computing platform 104, information received from external resources 124, or other information accessed by system 100 to function as described herein.

Processor(s) 128 are configured to coordinate the operation of the other components of system 100 to provide the functionality described herein. Processor(s) 128 may be configured to direct the operation of components 108-112 by software; hardware; firmware; some combination of software, hardware, or firmware; or other mechanisms for configuring processing capabilities.

It should be appreciated that although components 108-112 are illustrated in FIG. 1 as being co-located, one or more of components 108-112 may be located remotely from the other components. The description of the functionality provided by the different components 108-112 described below is for illustrative purposes, and is not intended to be limiting, as any of the components 108-112 may provide more or less functionality than is described, which is not to imply that other descriptions are limiting. For example, one or more of components 108-112 may be eliminated, and some or all of its functionality may be provided by others of the components 108-112, again which is not to imply that other descriptions are limiting. As another example, processor(s) 128 may be configured to control one or more additional components that may perform some or all of the functionality attributed below to one of the components 109-112. In some embodiments, server 102 (e.g., processor(s) 128 in addition to a cache server, a web server, and/or an API server) is executed in a single computing device, or in a plurality of computing devices in a datacenter, e.g., in a service oriented or micro-services architecture.

Scanning component 108 is configured to generate a user interface that comprises an augmented reality (AR) overlay on top of a live camera feed that facilitates positioning guidance information for a user controlling the camera feed in real-time for a scene at the location being scanned. The user interface may be presented to a user via a user computing platform 104, such as a smartphone, for example. The user computing platform 104 may include a camera and/or other components configured to provide the live camera feed.

In some embodiments, scanning component 108 may be configured to adapt the AR overlay based on underlying hardware capabilities of a user computing platform 104 and/or other information. For example, what works well on an iPhone 14 Pro might not work at all on a midrange Android phone. Some specific examples include—tracking how many AR nodes are visible in the scene and freeing up memory when they go off screen to free system resources for other tasks; generally attempting to minimize the number of polygons that are present in the AR scene, as this directly affects processing power; multithreading a display pipeline and recording pipeline so they can occur in parallel; and leveraging additional sensor data when present, e.g., the lidar sensor on higher end iPhones. This may be used to place 3D objects more accurately in a scene, but cannot be depended on all the time since some phones do not have Lidar sensors.

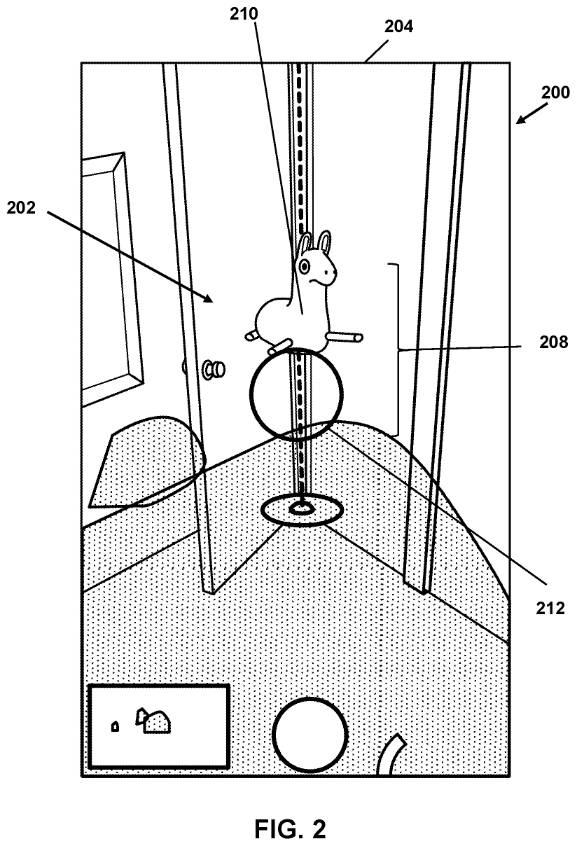

FIG. 2 illustrates an example user interface 200 that comprises an augmented reality (AR) overlay 202 on top of a live camera feed 204. AR overlay 202 facilitates positioning guidance information for a user controlling the camera feed 204 in real-time for a scene (e.g., a room in this example) at a location being scanned (e.g., a house in this example). The user interface 200 may be presented to a user via a user computing platform, such as a smartphone, for example.

Returning to FIG. 1, scanning component 108 is configured to provide a guide with the AR overlay that moves through the scene at the location during scanning such that the user can follow the guide. In some embodiments, the guide comprises a moving marker including one or more of a dot, a ball, a cartoon, and/or any other suitable moving marker. The moving marker may indicate a trajectory and/or other information. The moving marker and the trajectory are configured to cause the user to move the camera throughout the scene at the location.

Returning to the example shown in FIG. 2, AR overlay 202 comprises a guide 208, which in this example is formed by a cartoon 210, a circular indicator 212, and/or other components. Cartoon 210 is configured to move through the scene at the location during scanning such that the user can follow guide 208 with circular indicator 212. Cartoon 210 indicates a trajectory (by the direction the cartoon faces in this example) and/or other information. Cartoon 210 and the direction cartoon 210 is facing are configured to cause the user to move the camera as indicated by circular indicator 212 throughout the scene at the location. In this example, a user should follow cartoon 210 with circular indicator 212 so that cartoon 210 stays approximately within circular indicator 212 as cartoon 210 moves around the room (as facilitated by AR overlay 202).

In some embodiments, the guide (e.g., guide 208 in this example) comprises a real-time feedback indicator that shows an affirmative state if a user's position and/or motion is within allowed thresholds, or correction information if the user's position and/or motion breaches the allowed thresholds during the scan. In the example shown in FIG. 2, this may be accomplished by changing the appearance (e.g., changing a color, a brightness, a pattern, an opacity, etc.) of circular indicator 212 when circular indicator substantially surrounds cartoon 210.

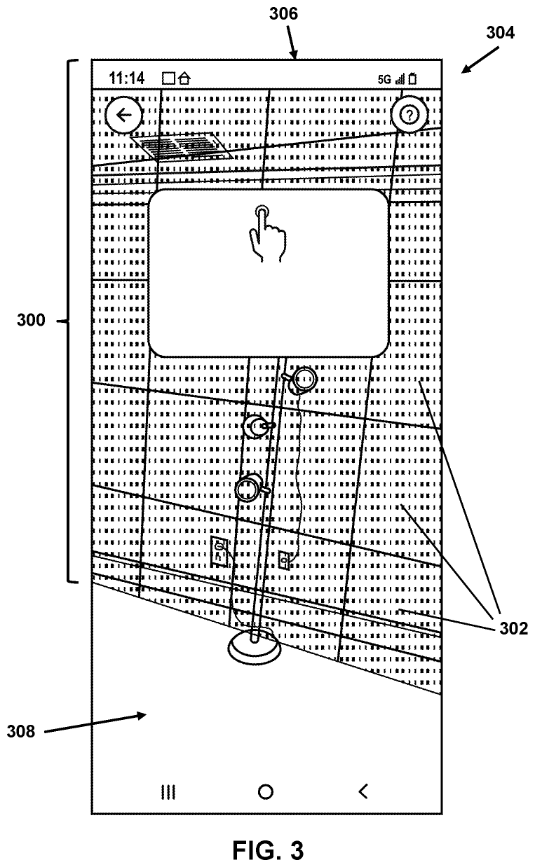

In some embodiments, the guide comprises a series of tiles configured to cause the user to follow motions indicated by the series of tiles with the camera throughout the scene at the location. FIG. 3 illustrates an example of a guide 300 that comprises a series of tiles 302. FIG. 3 illustrates another example of a user interface 304 (e.g., displayed by a user computer platform 104 shown in FIG. 1 such as a smartphone) that comprises an augmented reality (AR) overlay 306 on top of a live camera feed 308. AR overlay 306 facilitates positioning guidance information for a user controlling the camera feed 308 with tiles 302 in real-time for a scene (e.g., another room in this example) at a location being scanned (e.g., another house in this example). In this example, tiles 302 may show an affirmative state if a user's position and/or motion is within allowed thresholds, or correction information if the user's position and/or motion breaches the allowed thresholds during the scan. In the example shown in FIG. 3, this may be accomplished by changing the appearance (e.g., changing a color, a brightness, a pattern, an opacity, etc.) of tiles 302 as a user scans around the room, for example.

Returning to FIG. 1, in some embodiments, the guide is configured to follow a pre-planned route through the scene at the location. In some embodiments, the guide is configured to follow a route through the scene at the location determined in real-time during the scan. For example, different user computing platforms 104 (e.g., different smartphones in this example) may have different hardware, so scanning component 108 may be configured to account for different parameters to determine a route. Scanning component 108 may select a best camera in devices with multiple rear facing cameras, and a route may be planned for that camera. The route may vary based on the camera's field of view and/or other factors. For example, if a smartphone only has a camera with a wide angle or narrow field of view, scanning component 108 may change a route accordingly. Scanning component 108 may determine and/or change a route depending on a user handling orientation (landscape or portrait) or a smartphone, whether the smartphone includes an accelerometer and/or gyroscope, a sensitivity and/or accuracy of the accelerometer and/or gyroscope, etc. In the context of the examples shown in FIG. 2 and/or FIG. 3, a route may be indicated by cartoon 210 as cartoon 210 moves and changes direction around the scene, by a specific orientation and/or a certain sequential order of appearance of tiles 302, and/or by other indications of how the user should move through the scene.

In some embodiments, the guide and/or route causes rotational and translational motion by the user with the route. In some embodiments, the guide causes the user to scan areas of the scene at the location directly above and directly below the user with the route. For example, the route may lead a user to scan (e.g., when the scene comprises a typical room) up and down each wall, across the ceiling (including directly above the user's head), across the floor (including where the user is standing), and/or in other areas.

Conformance to the guide is tracked by scanning component 108 during the scanning to determine if a scanning motion by the user is within requirements. This may reduce a cognitive load on the user required to obtain a scan is reduced because the user is following the guide, and/or have other effects. Real-time feedback is provided to the user via the guide depending on a user adherence or lack of conformance to guide movements. As described above in the context of FIG. 2 and/or FIG. 3, this may be accomplished by changing the appearance (e.g., changing a color, a brightness, a pattern, an opacity, etc.) of circular indicator 212 when circular indicator substantially surrounds cartoon 210, changing the appearance (e.g., changing a color, a brightness, a pattern, an opacity, etc.) of tiles 302 as a user scans around the room, etc..

Scanning component 108 may be configured to encode the key movements a user must perform in the AR overlay/user interface. The AR overlay is configured to guide the user to make a quality scan, and if a situation is detected that is going to degrade the 3D reconstruction quality, scanning component 180 is configured to inform the user immediately (e.g., via the AR overlay) what they need to do differently. A few concrete examples include: 1. Animating the tile knock out approach (see FIG. 3 and corresponding description, which forces the user to slow down and gives the underlying camera time to autofocus. The user can't knock out the next tile until the previous tile is removed. 2. Monitoring light data and showing a warning (via the AR overlay) if the scene is too dark for tracking, and/or showing a suggestion to turn on a light. 3. Monitoring features in the scene and showing a warning to back up and show more of the scene if world tracking gets lost (e.g., if a user is too close to a wall such that no features on the wall may be detected). 4. Guiding the user to go in a path that allows some camera frames to overlap. This provides some redundancy so the 3D model can recover if a few frames were blurry. 5. Detecting occlusions and allowing the user to view an outline of the floor plan, even if the floor is not visible throughout the entire room (e.g., if a chair is blocking a corner).

As another example, the guide may be configured to adapt to a region of a scene being scanned (e.g., an indicator configured to increase height for pitched ceiling, detect particular problematic objects and cause the route followed by the user avoid these components (e.g., mirrors, televisions, windows, people, etc.) or cause virtual representation component 110 to ignore this data when generating the 3D virtual representation. Feedback provided to the user may be visual (e.g., via some change in the indicator and/or other aspects of the AR overlay), haptic (e.g., vibration) provided by a user computing platform 104, audio (e.g., provided by the user computing platform 104), and/or other feedback.

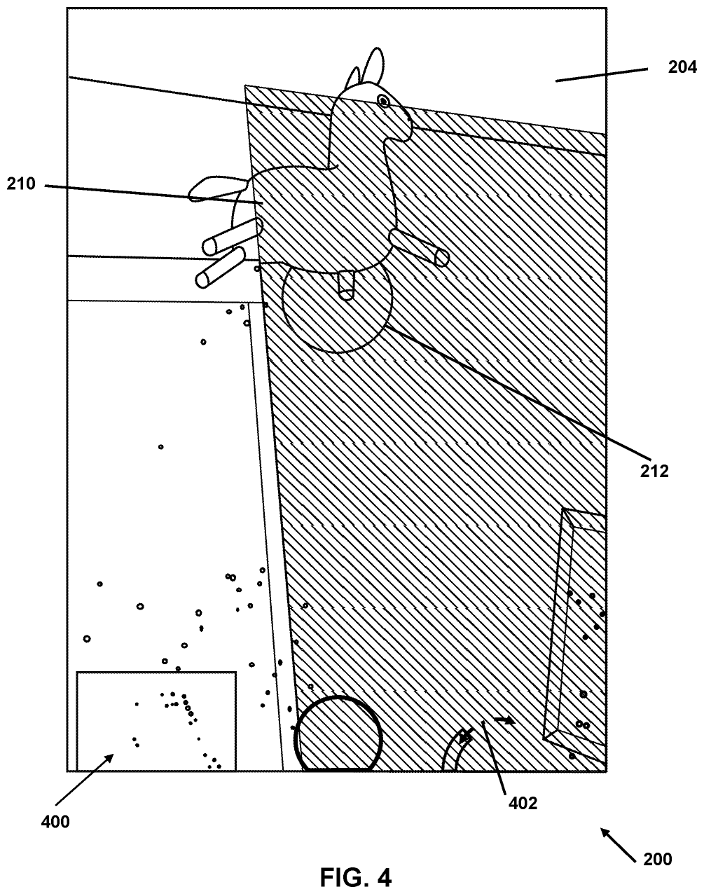

In some embodiments, scanning component 108 is configured such that the AR overlay comprises a mini map showing where a user is located in the scene at the location relative to a guided location; a speedometer showing a user's scan speed with the camera relative to minimum and/or maximum scan speed thresholds, and/or an associated warning; an indicator that informs the user whether illumination at the location is sufficient for the scan, and/or an associated warning; horizontal and/or vertical plane indicators; and/or other information. FIG. 4 illustrates two such examples. FIG. 4 illustrates a mini map 400 showing where a user is located in the scene at the location relative to a guided location; and a speedometer 402 showing a user's scan speed with the camera relative to minimum and/or maximum scan speed thresholds (bottom end of the rainbow shape and top end or maximum of the rainbow shape).

Returning to FIG. 1, scanning components 108 is configured to capture description data of the location and/or other information. The description data is generated via the camera and the user interface, and/or other components. The description data comprises a plurality of images and/or video of the location in the live camera feed, and/or other information. For example, the description data may include digital media such as red green blue (RGB) images, RGB-D (depth) images, RGB videos, RGB-D videos, inertial measurement unit (IMU) data, and/or other data.

In some embodiments, the description data comprises one or more media types. The media types may comprise video data, image data, audio data, text data, user interface/display data, sensor data, and/or other data. Capturing description data comprises receiving images and/or video from a camera, receiving sensor data from one or more environment sensors, and/or other operations. The one or more environment sensors may comprise a GPS, an accelerometer, a gyroscope, a barometer, a microphone, and/or other sensors. In some embodiments, the description data is captured by a mobile computing device associated with a user (e.g., a user computing platform 104) and transmitted to one or more processors 128 of the mobile computing device and/or an external server (e.g., server 102) with or without user interaction.

In some embodiments, the user interface may provide additional feedback to a user during a scan. The additional feedback may include, but is not limited to, real-time information about a status of the 3D virtual representation being constructed, natural language instructions to a user, audio or visual indicators of information being added to the 3D virtual representation, and/or other feedback. The user interface is also configured to enable a user to pause and resume data capture within the location.

Scanning component 108 is configured to record image frames from the plurality of images and/or video being collected from the camera, but not the AR overlay, such that the 3D virtual representation of the location is generated from the image frames from the camera, and the AR overlay is used to guide the user with the positioning guidance information, but is not needed after capture is complete. The 3D virtual representation generated by this process needs to be a faithful reconstruction of the actual room. As a result, the AR overlay is not drawn on top of the room in the resulting model, since that would obstruct the actual imagery observed in the room. However, user studies have shown that the user needs real-time instructional AR overlay tips. by implementing these in AR, the system can show spatially encoded tips (e.g., marking a corner of a room, showing a blinking tile on the wall where the user needs to point their phone, etc.). Thus, the user needs the annotations in the AR scene but the 3D representation reconstruction pipeline needs the raw video. Hence, the system is configured to generate and/or use a multithreaded pipeline where the camera frame is captured from the CMOS sensor, passed along the AR pipeline, and also captured and recorded to disk before the AR overlay is drawn on top of the buffer.

In some embodiments, prior to providing the guide with the AR overlay that moves through the scene at the location, scanning component 108 is configured to cause the AR overlay to use the user interface to make the user indicate a location of a floor, wall, and/or ceiling in the camera feed, and then provide the guide with the AR overlay that moves through the scene at the location based on the location of the floor, wall, and/or ceiling. In some embodiments, scanning component 108 is configured to automatically detect a location of a floor, wall, and/or ceiling in the camera feed, and providing the guide with the AR overlay that moves through the scene at the location based on the location of the floor, wall, and/or ceiling.

In some embodiments, this information (e.g., the location(s) of the floor, walls, and/or ceiling) provides measurements and/or the ability to determine measurements between two points in a scene, but may not be accurate because the (untrained) user might not place markers and/or other indications exactly on a floor, on a wall, on a ceiling, exactly in the corner of a room, etc.. However, these indications are still useable to determine a path for the guide to follow. Note that in some embodiments, this floor, wall, ceiling identification may be skipped. The user may instead be guided to start scanning any arbitrary point in a scene, and the guide may be configured to start there, and progress until a wall is detected, then pivot when the wall is detected. This would remove the need for the user to provide the path for the guide marker to follow, as the step may be determined algorithmically.

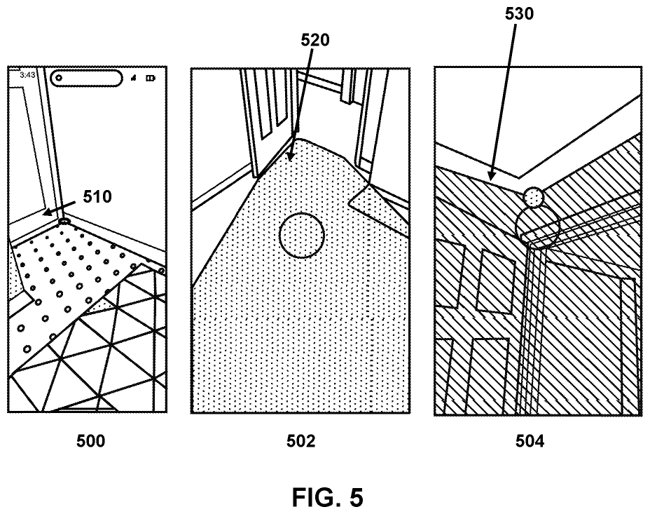

By way of a non-limiting example, FIG. 5 illustrates different example views of three different example user interfaces 500, 502, and 504 showing a user interface 500 causing the user to indicate a location 510 of on a floor at a corner with a wall and a door, automatically detecting a location 520 of a floor, and in the process of automatically detecting (the dot in interface 504 is moving up the wall toward the ceiling) the location 530 of a ceiling in a camera feed. The grid of dots on the floor in interface 500 is associated with an algorithm that estimates the floor plane. The user is instructed to tap the floor in the screen, and the camera pose information and world map are used to extrapolate out a plane from that point. This serves as a visual indicator where the user can see the floor plane extended through furniture, countertops, etc. This is useful for visualizing the perimeter to scan. Drawing the shading on location 520 of the floor in interface 502 is a useful interface indicator to show what part of the room is in bounds. Otherwise it's difficult to see where the bounds of the room are. This gives visual confirmation that the user scanned a correct area.

Returning to FIG. 1, in some embodiments, scanning component 108 is configured to provide a bounding box with the AR overlay. The bounding box is configured to be manipulated by the user via the user interface to indicate the location of one or more of a floor, a wall, a ceiling, and/or an object in the scene at the location, Scanning component 108 is configured to provide the guide with the AR overlay that moves through the scene at the location based on the bounding box. A bounding box may be used to indicate an area of a scene that should be scanned (e.g., an entire room, part of a room, etc.). For example, a bounding box may be dragged to mark a ceiling height. This may provide an upper bound of where the guide should move between (e.g., floor to ceiling). In some embodiments, scanning component 108 is configured such that a form and/or other options for entry and/or selection of data may be presented to the user via the user interface to input base measurements of the scene (e.g., a room) for the guide to use as boundaries.

Three dimensional (3D) virtual representation component 110 is configured to generate the 3D virtual representation. The 3D virtual representation comprises a virtual representation of the scene at the location, elements therein (e.g., surfaces, tables, chairs, books, computers, walls, floors, ceilings, decorations, windows, doors, etc.), and/or other information. In some embodiments, the 3D virtual representation may be represented as a 3D model of the scene and/or location with metadata comprising data associated images, videos, natural language, camera trajectory, and geometry, providing information about the contents and structures in or at the scene and/or location, as well as their costs, materials, and repair histories, among other application-specific details. The metadata may be spatially localized and referenced on the 3D virtual representation. In some embodiments, the 3D representation may be in the form of a mesh at metric scale, or other units. In some embodiments, the 3D representation may be in the form of a mesh or point cloud, generated from a set of associated posed RGB or RGB-D images and/or video.

Virtual representation component 110 is configured for generating the 3D virtual representation in real-time, via a machine learning model and/or a geometric model. In some embodiments, the 3D virtual representation may be generated via a machine learning model and/or a geometric model comprising one or more neural networks, which model a network as a series of one or more nonlinear weighted aggregations of data. Typically, these networks comprise sequential layers of aggregations with varying dimensionality. This class of algorithms are generally considered to be able to approximate any mathematical function. One or more of the neural networks may be a “convolutional neural network” (CNN). A CNN refers to a particular neural network having an input layer, hidden layers, and an output layer and configured to perform a convolution operation. The hidden layers (also referred as convolutional layers) convolve the input and pass its result to the next layer.

The machine learning model and/or the geometric model are configured to receive the plurality of images and/or video, along with pose matrices, as inputs, and predict geometry of the location, the elements, and/or the objects therein to form the 3D virtual representation. In some embodiments, generating the 3D virtual representation comprises encoding each image of the plurality of images and/or video with the machine learning model, adjusting, based on the encoded images of the plurality of images, an intrinsics matrix associated with the camera; using the intrinsics matrix and pose matrices to back-project the encoded images into a predefined voxel grid volume; and providing the voxel grid as input to a neural network to predict a 3D model of the location for each voxel in the voxel grid. The intrinsics matrix represents physical attributes of a camera. The physical attributes comprise things like focal length, principal point, and skew, for example. A pose matrix represents a relative or absolute orientation of the camera in a virtual world. The pose matrix comprises 3-degrees-of-freedom rotation of the camera and a 3-degrees-of-freedom position in a virtual representation.

In some embodiments, virtual representation component 110 is configured to estimate pose matrices and intrinsics for each image of the plurality of images and/or video by a geometric reconstruction framework. This framework is configured to triangulate 3D points based on the plurality of images and/or video to estimate both camera poses up to scale and camera intrinsics. The pose matrices and intrinsics may be input to a machine learning model to accurately predict the 3D virtual representation of the location, for example. A geometric reconstruction framework may comprise structure-from-motion (SFM), multi-view stereo (MVS), simultaneous localization and mapping (SLAM), and/or other frameworks.

In some embodiments, a device (e.g., a user computing platform 104 shown in FIG. 1) may not be configured to generate the 3D virtual representation due to memory or processing power limitations of a device. In this case, the operations of generating the 3D virtual representation in real-time may be distributed on different servers or processors. In some embodiments, the 3D virtual representation is generated, in real-time, by receiving, at a user device (e.g., a user computing platform 104), the description data of the location. The description data is transmitted to a server (e.g., server 102) configured to execute the machine learning model to generate the 3D virtual representation of the location. The 3D virtual representation is generated at the server based on the machine learning model and the description data. The 3D virtual representation is transmitted to the user device (e.g., for the user's real-time review).

Annotation component 112 is configured to annotate the 3D virtual representation of the location with spatially localized metadata associated with the elements within the location, and semantic information of the elements within the location. Semantic information may comprise a label and/or category associated with pixels in an image and/or video, for example. The labels and/or categories may describe what something is (e.g., a floor, wall, ceiling, table, chair, mirror, book, etc.) in an image and/or video. Annotation component 112 is configured to make the 3D virtual representation editable by the user (e.g., via a user interface described herein) to allow modifications to the spatially localized metadata.

In some embodiments, annotating the 3D virtual representation with spatially localized metadata comprises spatially localizing the metadata using a geometric estimation model, or manual entry of the metadata via the user interface. In some embodiments, spatially localizing of the metadata comprises receiving additional images of the location and associating the additional images to the 3D virtual representation of the location; computing camera poses associated with the additional images with respect to the plurality of images and/or video and the 3D virtual representation; and relocalizing, via the geometric estimation model and the camera poses, the additional images and associating metadata.

Metadata associated with an element comprises geometric properties of the element; material specifications of the element; a condition of the element; receipts related to the element; invoices related to the element; spatial measurements captured through the 3D virtual representation or physically at the location; audio, visual, or natural language notes; 3D shapes and objects including geometric primitives and CAD models; and/or other metadata.

In some embodiments, metadata refers to a set of data that describes and gives information about other data. For example, the metadata associated with an image and/or video may include items such as a GPS coordinates of the location where the image and/or video was taken, the date and time it was taken, camera type and image capture settings, the software used to edit the image, or other information related to the image, the location or the camera. In an embodiment, the metadata may include information about elements of the locations, such as information about a wall, a chair, a bed, a floor, a carpet, a window, or other elements that may be present in the captured images or video. For example, metadata of a wall may include dimensions, type, cost, material, repair history, old images of the wall, or other relevant information. In an embodiment, a user may specify audio, visual, geometric, or natural language metadata including, but not limited to, natural language labels, materials, costs, damages, installation data, work histories, priority levels, and application-specific details, among other pertinent information. The metadata may be sourced from a database or uploaded by the user. In an embodiment, the metadata may be spatially localized on the 3D virtual representation and/or be associated with a virtual representation. For example, a user may attach high-resolution images of the scene and associated comments to a spatially localized annotation in the 3D virtual representation in order to better indicate a feature of the location. In another example, a user can interactively indicate the sequence of corners and walls corresponding to the layout of the location to create a floor plan. In yet another example, the metadata may be a CAD model of an element or a location, and/or geometric information of the elements in the CAD model. Specific types of metadata can have unique, application-specific viewing interfaces through a user interface. As an example, the metadata associated with an element in a scene at a location may include, but is not limited to, geometric properties of the element; material specifications of the element; a condition of the element; receipts related to the element; invoices related to the element; spatial measurements captured through the 3D virtual representation or physically at the location; details about insurance coverage; audio, visual, or natural language notes; or 3D shapes and objects including geometric primitives and CAD models.

In some embodiments, the metadata may be automatically inferred using, e.g., a 3D object detection algorithm, where a machine learning model is configured to output semantic segmentation or instance segmentation of objects in an input image, or other approaches. In an embodiment, a machine learning model may be trained to use a 3D virtual representation and metadata as inputs, and spatially localize the metadata based on semantic or instance segmentation of the 3D virtual representation. In some embodiments, spatially localizing the metadata may involve receiving additional images of the location and associating the additional images to the 3D virtual representation of the location; computing camera poses associated with the additional images with respect to the existing plurality of images and the 3D model using a geometric estimation or a machine learning model configured to estimate camera poses; and associating the metadata to the 3D virtual representation. In some embodiments, the additional images may be captured by a user via a camera in different orientations and settings.

In some embodiments, annotating the 3D virtual representation with the semantic information comprises identifying elements from the plurality of images, the video, and/or the 3D virtual representation by a semantically trained machine learning model. The semantically trained machine learning model is configured to perform semantic or instance segmentation and 3D object detection and localization of each object in an input image.

In some embodiments, a user interface (e.g., of a user computing platform 104) may be provided for displaying and interacting with the 3D virtual representation of a physical scene at a location and its associated information. The graphical user interface provides multiple capabilities for users to view, edit, augment, and otherwise modify the 3D virtual representation and its associated information. The graphical user interface enables additional information to be spatially associated within a context of the 3D virtual representation. This additional information may be in the form of semantic or instance annotations; 3D shapes such as parametric primitives including, but not limited to, cuboids, spheres, cylinders and CAD models; and audio, visual, or natural language notes, annotations, and comments or replies thereto. The user interface is also configured to enable a user to review previously captured scenes, merge captured scenes, add new images and videos to a scene, and mark out a floor plan of a scene, among other capabilities.

The automation enabled by the present disclosure utilizes machine learning, object detection from video or images, semantic segmentation, sensors, and other related technology. For example, information related to the detected objects can be automatically determined and populated as data into the 3D virtual representation of a location.

As used herein, “CAD model” refers to a 3D model of a structure, object, or geometric primitive that has been manually constructed or improved using computer-aided design (CAD) tools. “Extrinsics matrix” refers to a matrix representation of the rigid-body transformation between a fixed 3-dimensional Cartesian coordinate system defining the space of a virtual world and a 3-dimensional Cartesian coordinate system defining that world from the viewpoint of a specific camera. “Inertial measurement unit” (IMU) refers to a hardware unit comprising accelerometers, gyroscopes, and magnetometers that can be used to measure the motion of a device in physically-meaningful units. “Intrinsics matrix” refers to a matrix representation of physical attributes of a real camera comprising focal length, principal point, and skew. “Point cloud” refers to a collection of 3-dimensional points, wherein each point has information comprising 3D position, color information, and surface normal information, among other pertinent data. “Mesh” refers to an explicit representation of a 3D surface consisting of vertices connected by edges. The vertices comprise the same information as a 3D point cloud, with the possible addition of texture coordinates, while the edges define planar surfaces called faces, typically triangular or quadrilateral, which themselves may comprise color information, surface normals, among other pertinent data. “Pose matrix” refers to a matrix representation of a camera's relative or absolute orientation in the virtual world, comprising the 3-degrees-of-freedom rotation of the camera, and the 3-degrees-of-freedom position of the camera in the world. This is the inverse of the extrinsics matrix. The pose may refer to a combination of position and orientation or orientation only. “Posed image” refers to an RGB or RGB-D image with associated information describing the capturing camera's relative orientation in the world, comprising the intrinsics matrix and one of the pose matrix or extrinsics matrix. “RGB image” refers to a 3-channel image representing a view of a captured scene using a color space, wherein the color is broken up into red, green, and blue channels. “RGB-D image” refers to a 4-channel image consisting of an RGB image augmented with a depth map as the fourth channel. The depth can represent the straight-line distance from the image plane to a point in the world, or the distance along a ray from the camera's center of projection to a point in the world. The depth information can contain unitless relative depths up to a scale factor or metric depths representing absolute scale. The term RGB-D image can also refer to the case where a 3-channel RGB image has an associated 1-channel depth map, but they are not contained in the same image file. “Signed distance function” (SDF) refers to a function that provides an implicit representation of a 3D surface, and may be stored on a voxel grid, wherein each voxel stores the distance to the closest point on a surface. The original surface can be recovered using an algorithm of the class of isosurface extraction algorithms comprising marching cubes, among others. “Structure from Motion” (SFM) refers to a class of algorithms that estimate intrinsics and extrinsic camera parameters, as well as a scene structured in the form of a sparse point cloud. SFM can be applied to both ordered image data, such as frames from a video, as well as unordered data, such as random images of a scene from one or more different camera sources. Traditionally, SFM algorithms are computationally expensive and are used in an offline setting. “Multi-view stereo” (MVS) refers to an algorithm that builds a 3D model of an object by combining multiple views of that object taken from different vantage points. “Simultaneous localization and mapping” (SLAM) refers to a class of algorithms that estimate both camera pose and scene structure in the form of point cloud. SLAM is applicable to ordered data, for example, a video stream. SLAM algorithms may operate at interactive rates, and can be used in online settings. “Textured mesh” refers to a mesh representation wherein the color is applied to the mesh surface by UV mapping the mesh's surface to RGB images called texture maps that contain the color information for the mesh surface. “Voxel” refers to a portmanteau of “volume element.” Voxels are cuboidal cells of 3D grids and are effectively the 3D extension of pixels. Voxels can store various types of information, including occupancy, distance to surfaces, colors, and labels, among others. “Wireframe” refers to a visualization of a mesh's vertices and edges, revealing the topology of the underlying representation.

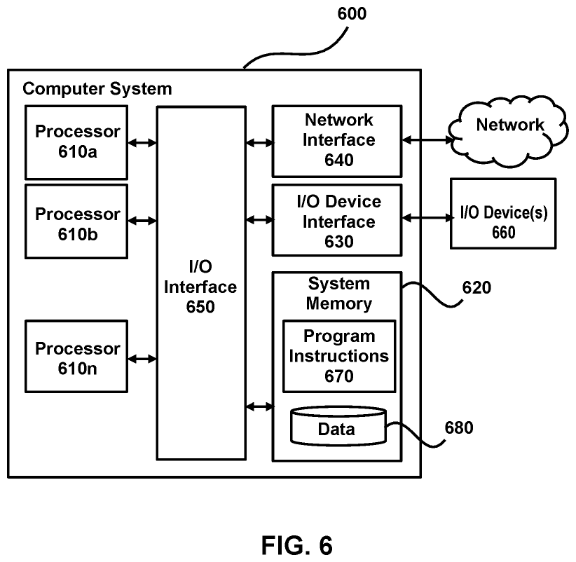

FIG. 6 is a diagram that illustrates an exemplary computer system 600 in accordance with embodiments described herein. Various portions of systems and methods described herein, may include or be executed on one or more computer systems the same as or similar to computer system 600. For example, server 102, user computing platform(s) 104, external resources 124, and/or other components of system 100 (FIG. 1) may be and/or include one more computer systems the same as or similar to computer system 600. Further, processes, modules, processor components, and/or other components of system 100 described herein may be executed by one or more processing systems similar to and/or the same as that of computer system 600.

Computer system 600 may include one or more processors (e.g., processors 610a-610n) coupled to system memory 620, an input/output I/O device interface 630, and a network interface 640 via an input/output (I/O) interface 650. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computer system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computer system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computer system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on a remote computer system, for example, may be connected to computer system 600 via a network and network interface 640.

Network interface 640 may include a network adapter that provides for connection of computer system 600 to a network. Network interface may 640 may facilitate data exchange between computer system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Instructions 670 may include modules and/or components (e.g., components 108-112 shown in FIG. 1) of computer program instructions for implementing one or more techniques described herein with regard to various processing modules and/or components. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 620 (which may be similar to and/or the same as electronic storage 126 shown in FIG. 1) may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 620 may include a non-transitory computer readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600 or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a television or device connected to a television (e.g., Apple TV™), or a Global Positioning System (GPS), or the like. Computer system 600 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

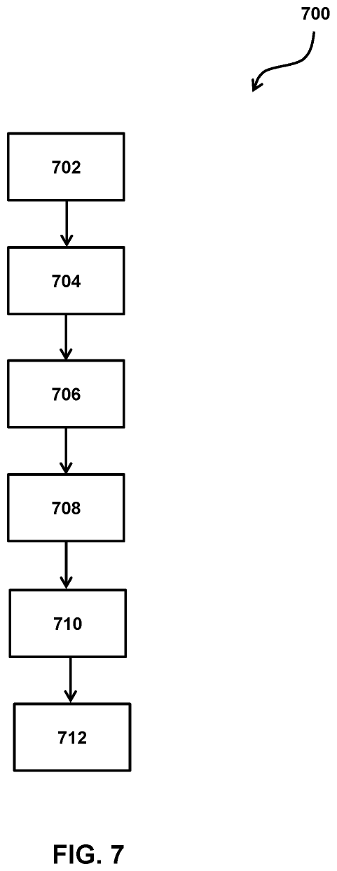

FIG. 7 is a flowchart of a method 700 for generating a three dimensional (3D) virtual representation of a location with spatially localized information of elements within the location being embedded in the 3D virtual representation is provided, including generating a user interface that includes an augmented reality (AR) overlay on top of a live camera feed. Method 700 may be performed with some embodiments of system 100 (FIG. 1), computer system 600 (FIG. 6), and/or other components discussed above. Method 700 may include additional operations that are not described, and/or may not include one or more of the operations described below. The operations of method 700 may be performed in any order that facilitates generation of an accurate 3D virtual representation of a location.

Method 700 comprises generating (operation 702) a user interface that includes an augmented reality (AR) overlay on top of a live camera feed. This facilitates positioning guidance information for a user controlling the camera feed in real-time for a scene at the location being scanned. The method comprises providing (operation 704) a guide with the AR overlay that moves through the scene at the location during scanning such that the user can follow the guide, and conformance to the guide can be tracked during the scanning to determine if a scanning motion by the user is within requirements, and such that a cognitive load on the user required to obtain a scan is reduced because the user is following the guide. Real-time feedback is provided to the user via the guide depending on a user adherence or lack of conformance to guide movements. The method comprises (operation 706) capturing description data of the location. The description data is generated via the camera and the user interface. The description data comprises a plurality of images and/or video of the location in the live camera feed. The method comprises recording (operation 708) image frames from the plurality of images and/or video being collected from the camera, but not the AR overlay, such that the 3D virtual representation of the location is generated (operation 710) from the image frames from the camera, and the AR overlay is used to guide the user with the positioning guidance information, but is not needed after capture is complete. The method comprises annotating (operation 712) the 3D virtual representation of the location with spatially localized metadata associated with the elements within the location, and semantic information of the elements within the location. The 3D virtual representation is editable by the user to allow modifications to the spatially localized metadata. Each of these operations of method 700 may be completed as described above with reference to FIG. 1-FIG. 6.

In block diagrams such as FIG. 7, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network (e.g., as describe above with respect to FIG. 1).

As described above, the results of the present disclosure may be achieved by one or more machine learning models that cooperatively work with each other to generate a 3D virtual representation. For example, in an embodiment, a first machine learning model may be configured to generate a 3D virtual representation, a second machine learning model may be trained to generate semantic segmentation or instance segmentation information or object detections from a given input image, a third machine learning model may be configured to estimate pose information associated with a given input image, and a fourth machine learning model may be configured to spatially localize metadata to an input image or an input 3D virtual representation (e.g., generated by the first machine learning model). In another embodiment, a first machine learning model may be configured to generate a 3D virtual representation, a second machine learning model may be trained to generate semantic segmentation or instance segmentation information or object detections from a given input 3D virtual representation or images, and a third machine learning model may be configured to spatially localize metadata to an input 3D virtual representation or images. In an embodiment, two or more of the machine learning models may be combined into a single machine learning model by training the single machine learning model accordingly. In the present disclosure, a machine learning model may not be identified by specific reference numbers like “first,” “second,” “third,” and so on, but the purpose of each machine learning model will be clear from the description and the context discussed herein. Accordingly, a person of ordinary skill in the art may modify or combine one or more machine learning models to achieve the effects discussed herein. Also, although some features may be achieved by a machine learning model, alternatively, an empirical model, an optimization routine, a mathematical equation (e.g., geometry-based), etc. may be used.

In the discussion below, the term artificial intelligence or AI, “AI” may refer to relating to a machine learning model discussed herein. “AI framework” may also refer to a machine learning model. “AI algorithm” may refer to a machine learning algorithm. “AI improvement engine” may refer to a machine learning based optimization. “3D mapping” or “3D reconstruction” may refer to generating a 3D virtual representation (according to one or more methods discussed herein).

The present disclosure involves using computer vision using cameras and optional depth sensors on a smartphone and/or inertial measurement unit (IMU) data (e.g., data collected from an accelerometer, a gyroscope, a magnetometer, and/or other sensors) in addition to text data: questions asked by a human agent or an AI algorithm based on sent RGB and/or RGB-D images and/or videos, and previous answers as well as answers by the consumer on a mobile device (e.g., smartphone, tablet, and/or other mobile device) to come up with an estimate of how much it will cost to perform a moving job, a paint job, obtain insurance, perform a home repair, and/or other services. These examples are not intended to be limiting.

In some embodiments, a workflow may include a user launching an app or another messaging channel (SMS, MMS, web browser, etc.) and scanning a location (e.g., a home and/or another location) where camera(s) data and/or sensor(s) data may be collected. The app may use the camera and/or IMU and optionally a depth sensor to collect and fuse data to detect surfaces to be painted, objects to be moved, etc. and estimate their surface area data, and/or move related data, in addition to answers to specific questions. An AI algorithm (e.g., neural network) specifically trained to identify key elements may be used (e.g., walls, ceiling, floor, furniture, wall hangings, appliances, and/or other objects). Other relevant characteristics may be detected including identification of light switch/electrical outlets that would need to be covered or replaced, furniture that would need to be moved, carpet/flooring that would need to be covered, and/or other relevant characteristics.

A 3D virtual representation may include semantic segmentation or instance segmentation annotations for each element of the room. Based on dimensioning of the elements further application specific estimations or analysis may be performed. As an example, for one or more rooms, the system may give an estimated square footage on walls, trim, ceiling, baseboard, door, and/or other items (e.g., for a painting example); the system may give an estimated move time and/or move difficulty (e.g., for a moving related example), and or other information.

In some embodiments, an artificial intelligence (AI) model may be trained to recognize surfaces, elements, etc., in accordance with one or more implementations. Multiple training images with surfaces, elements, etc. that need to be detected may be presented to an artificial intelligence (AI) framework for training. Training images may contain non-elements such as walls, ceilings, carpets, floors, and/or other non-elements. Each of the training images may have annotations (e.g., location of elements of desire in the image, coordinates, and/or other annotations) and/or pixel wise classification for elements, walls, floors, and/or other training images. Responsive to training being complete, the trained model may be sent to a deployment server (e.g., server 102 shown in FIG. 1) running an AI framework. It should be noted that training data is not limited to images and may include different types of input such as audio input (e.g., voice, sounds, etc.), user entries and/or selections made via a user interface, scans and/or other input of textual information, and/or other training data. The AI algorithms may, based on such training, be configured to recognize voice commands and/or input, textual input, etc.

In the following list, further features, characteristics, and exemplary technical solutions of the present disclosure will be described in terms of items that may be optionally claimed in any combination:
Item 1: A non-transitory machine-readable medium storing instructions which, when executed by at least one programmable processor, cause the at least one programmable processor to perform operations comprising: generating a user interface that comprises an augmented reality (AR) overlay on top of a live camera feed that facilitates positioning guidance information for a user controlling the camera feed in real-time for a scene at a location being scanned; providing a guide with the AR overlay that moves through the scene at the location during scanning such that the user can follow the guide, and conformance to the guide can be tracked during the scanning to determine if a scanning motion by the user is within requirements, and such that a cognitive load on the user required to obtain a scan is reduced because the user is following the guide, wherein real-time feedback is provided to the user via the guide depending on a user adherence or lack of conformance to guide movements; capturing description data of the location, the description data being generated via the camera and the user interface, the description data comprising a plurality of images and/or video of the location in the live camera feed; recording image frames from the plurality of images and/or video being collected from the camera, but not the AR overlay, such that a resulting three dimensional (3D) virtual representation of the location is generated from the image frames from the camera, and the AR overlay is used to guide the user with the positioning guidance information, but is not needed after capture is complete; and annotating the 3D virtual representation of the location with spatially localized metadata associated with elements within the location, and semantic information of the elements within the location, the 3D virtual representation being editable by the user to allow modifications to the spatially localized metadata.
Item 2: The medium of item 1, wherein the guide comprises a moving marker including one or more of a dot, a ball, or a cartoon, and indicates a trajectory, the moving marker and the trajectory configured to cause the user to move the camera throughout the scene at the location.
Item 3: The medium of any previous item, wherein the guide comprises a series of tiles configured to cause the user to follow motions indicated by the series of tiles with the camera throughout the scene at the location.
Item 4: The medium of any previous item, wherein the guide is configured to follow a pre-planned route through the scene at the location.
Item 5: The medium of any previous item, wherein the guide is configured to follow a route through the scene at the location determined in real-time during the scan.
Item 6: The medium of any previous item, wherein the guide causes rotational and translational motion by the user.
Item 7: The medium of any previous item, wherein the guide causes the user to scan areas of the scene at the location directly above and directly below the user.
Item 8: The medium of any previous item, the operations further comprising, prior to providing the guide with the AR overlay that moves through the scene at the location, causing the AR overlay to use the user interface to make the user indicate a location of a floor, wall, and/or ceiling in the camera feed, and then providing the guide with the AR overlay that moves through the scene at the location based on the location of the floor, wall, and/or ceiling.
Item 9: The medium of any previous item, the operations further comprising, automatically detecting a location of a floor, wall, and/or ceiling in the camera feed, and providing the guide with the AR overlay that moves through the scene at the location based on the location of the floor, wall, and/or ceiling.
Item 10: The medium of any previous item, the operations further comprising providing a bounding box with the AR overlay configured to be manipulated by the user via the user interface to indicate the location of one or more of a floor, a wall, a ceiling, and/or an object in the scene at the location, and providing the guide with the AR overlay that moves through the scene at the location based on the bounding box.
Item 11: The medium of any previous item, wherein the guide comprises a real-time feedback indicator that shows an affirmative state if a user's position and/or motion is within allowed thresholds, or correction information if the user's position and/or motion breaches the allowed thresholds during the scan.
Item 12: The medium of any previous item, wherein the AR overlay further comprises: a mini map showing where a user is located in the scene at the location relative to a guided location; a speedometer showing a user's scan speed with the camera relative to minimum and/or maximum scan speed thresholds, and/or an associated warning; an indicator that informs the user whether illumination at the location is sufficient for the scan, and/or an associated warning; and/or horizontal and/or vertical plane indicators.
Item 13: The medium of any previous item, the operations further comprising: generating, in real-time, via a machine learning model and/or a geometric model, the 3D virtual representation of the location and elements therein, the machine learning model and/or the geometric model being configured to receive the plurality of images and/or video, along with pose matrices, as inputs, and predict geometry of the location and the elements therein to form the 3D virtual representation.
Item 14: The medium of any previous item 3, wherein generating the 3D virtual representation comprises encoding each image of the plurality of images and/or video with the machine learning model; adjusting, based on the encoded images of the plurality of images, an intrinsics matrix associated with the camera; using the intrinsics matrix and pose matrices to back-project the encoded images into a predefined voxel grid volume; and providing the voxel grid as input to a neural network to predict a 3D model of the location for each voxel in the voxel grid.
Item 15: The medium of any previous item, wherein the intrinsics matrix represents physical attributes of a camera, the physical attributes comprising: focal length, principal point, and skew.
Item 16: The medium of any previous item, wherein a pose matrix represents a relative or absolute orientation of the camera in a virtual world, the pose matrix comprising 3-degrees-of-freedom rotation of the camera and a 3-degrees-of-freedom position in a virtual representation.
Item 17: The medium of any previous item, wherein annotating the 3D virtual representation with spatially localized metadata comprises spatially localizing the metadata using a geometric estimation model, or manual entry of the metadata via the user interface, wherein spatially localizing of the metadata comprises: receiving additional images of the location and associating the additional images to the 3D virtual representation of the location; computing camera poses associated with the additional images with respect to an existing plurality of images and/or video and the 3D virtual representation; and relocalizing, via the geometric estimation model and the camera poses, the additional images and associating metadata.
Item 18: The medium of any previous item, wherein metadata associated with an element comprises at least one of: geometric properties of the element; material specifications of the element; a condition of the element; receipts related to the element; invoices related to the element; spatial measurements captured through the 3D virtual representation or physically at the location; audio, visual, or natural language notes; or 3D shapes and objects including geometric primitives and CAD models.
Item 19. The medium of any previous item, wherein annotating the 3D virtual representation with the semantic information comprises: identifying elements from the plurality of images, the video, and/or the 3D virtual representation by a semantically trained machine learning model, the semantically trained machine learning model configured to perform semantic or instance segmentation and 3D object detection and localization of each object in an input image.
Item 20: The medium of any previous item, wherein the description data further comprises one or more media types, the media types comprising at least one or more of video data, image data, audio data, text data, user interface/display data, and/or sensor data.
Item 21: The medium of any previous item, wherein capturing description data further comprises receiving sensor data from one or more environment sensors, the one or more environment sensors comprising at least one of a GPS, an accelerometer, a gyroscope, a barometer, or a microphone.
Item 22: The medium of any previous item, wherein the description data is captured by a mobile computing device associated with a user and transmitted to one or more processors of the mobile computing device and/or an external server with or without user interaction.
Item 23: The medium of any previous item, the operations further comprising generating, in real-time, the 3D virtual representation by: receiving, at a user device, the description data of the location, transmitting the description data to a server configured to execute a machine learning model to generate the 3D virtual representation of the location, generating, at the server based on the machine learning model and the description data, the 3D virtual representation of the location, and transmitting the 3D virtual representation to the user device.
Item 24: The medium of any previous item, the operations further comprising: estimating pose matrices and intrinsics for each image of the plurality of images and/or video by a geometric reconstruction framework configured to triangulate 3D points based on the plurality of images and/or video to estimate both camera poses up to scale and camera intrinsics, and inputting the pose matrices and intrinsics to a machine learning model to accurately predict the 3D virtual representation of the location.
Item 25: The medium of any previous item, wherein the geometric reconstruction framework comprises at least one of: structure-from-motion (SFM), multi-view stereo (MVS), or simultaneous localization and mapping (SLAM).
Item 26: A method for generating a three dimensional (3D) virtual representation of a location with spatially localized information of elements within the location being embedded in the 3D virtual representation, the method comprising: generating a user interface that comprises an augmented reality (AR) overlay on top of a live camera feed that facilitates positioning guidance information for a user controlling the camera feed in real-time for a scene at the location being scanned; providing a guide with the AR overlay that moves through the scene at the location during scanning such that the user can follow the guide, and conformance to the guide can be tracked during the scanning to determine if a scanning motion by the user is within requirements, and such that a cognitive load on the user required to obtain a scan is reduced because the user is following the guide, wherein real-time feedback is provided to the user via the guide depending on a user adherence or lack of conformance to guide movements; capturing description data of the location, the description data being generated via the camera and the user interface, the description data comprising a plurality of images and/or video of the location in the live camera feed; recording image frames from the plurality of images and/or video being collected from the camera, but not the AR overlay, such that the 3D virtual representation of the location is generated from the image frames from the camera, and the AR overlay is used to guide the user with the positioning guidance information, but is not needed after capture is complete; and annotating the 3D virtual representation of the location with spatially localized metadata associated with the elements within the location, and semantic information of the elements within the location, the 3D virtual representation being editable by the user to allow modifications to the spatially localized metadata.
Item 27: The method of item 26, wherein the guide comprises a moving marker including one or more of a dot, a ball, or a cartoon, and indicates a trajectory, the moving marker and the trajectory configured to cause the user to move the camera throughout the scene at the location.
Item 28: The method of any previous item, wherein the guide comprises a series of tiles configured to cause the user to follow motions indicated by the series of tiles with the camera throughout the scene at the location.
Item 29: The method of any previous item, wherein the guide is configured to follow a pre-planned route through the scene at the location.
Item 30: The method of any previous item, wherein the guide is configured to follow a route through the scene at the location determined in real-time during the scan.
Item 31: The method of any previous item, wherein the guide causes rotational and translational motion by the user.
Item 32: The method of any previous item, wherein the guide causes the user to scan areas of the scene at the location directly above and directly below the user.
Item 33: The method of any previous item, the method further comprising, prior to providing the guide with the AR overlay that moves through the scene at the location, causing the AR overlay to use the user interface to make the user indicate a location of a floor, wall, and/or ceiling in the camera feed, and then providing the guide with the AR overlay that moves through the scene at the location based on the location of the floor, wall, and/or ceiling.
Item 34: The method of any previous item, the method further comprising, automatically detecting a location of a floor, wall, and/or ceiling in the camera feed, and providing the guide with the AR overlay that moves through the scene at the location based on the location of the floor, wall, and/or ceiling.
Item 35: The method of any previous item, the method further comprising providing a bounding box with the AR overlay configured to be manipulated by the user via the user interface to indicate the location of one or more of a floor, a wall, a ceiling, and/or an object in the scene at the location, and providing the guide with the AR overlay that moves through the scene at the location based on the bounding box.
Item 36. The method of any previous item, wherein the guide comprises a real-time feedback indicator that shows an affirmative state if a user's position and/or motion is within allowed thresholds, or correction information if the user's position and/or motion breaches the allowed thresholds during the scan.
Item 37. The method of any previous item, wherein the AR overlay further comprises: a mini map showing where a user is located in the scene at the location relative to a guided location; a speedometer showing a user's scan speed with the camera relative to minimum and/or maximum scan speed thresholds, and/or an associated warning; an indicator that informs the user whether illumination at the location is sufficient for the scan, and/or an associated warning; and/or horizontal and/or vertical plane indicators.
Item 38: The method of any previous item, the method further comprising: generating, in real-time, via a machine learning model and/or a geometric model, the 3D virtual representation of the location and elements therein, the machine learning model and/or the geometric model being configured to receive the plurality of images and/or video, along with pose matrices, as inputs, and predict geometry of the location and the elements therein to form the 3D virtual representation.
Item 39: The method of any previous item, wherein generating the 3D virtual representation comprises: encoding each image of the plurality of images and/or video with the machine learning model; adjusting, based on the encoded images of the plurality of images, an intrinsics matrix associated with the camera; using the intrinsics matrix and pose matrices to back-project the encoded images into a predefined voxel grid volume; and providing the voxel grid as input to a neural network to predict a 3D model of the location for each voxel in the voxel grid.
Item 40: The method of any previous item, wherein the intrinsics matrix represents physical attributes of a camera, the physical attributes comprising: focal length, principal point, and skew.
Item 41: The method of any previous item, wherein a pose matrix represents a relative or absolute orientation of the camera in a virtual world, the pose matrix comprising 3-degrees-of-freedom rotation of the camera and a 3-degrees-of-freedom position in a virtual representation.
Item 42: The method of any previous item, wherein annotating the 3D virtual representation with spatially localized metadata comprises spatially localizing the metadata using a geometric estimation model, or manual entry of the metadata via the user interface, wherein spatially localizing of the metadata comprises: receiving additional images of the location and associating the additional images to the 3D virtual representation of the location; computing camera poses associated with the additional images with respect to the plurality of images and/or video and the 3D virtual representation; and relocalizing, via the geometric estimation model and the camera poses, the additional images and associating metadata.
Item 43: The method of any previous item, wherein metadata associated with an element comprises at least one of: geometric properties of the element; material specifications of the element; a condition of the element; receipts related to the element; invoices related to the element; spatial measurements captured through the 3D virtual representation or physically at the location; audio, visual, or natural language notes; or 3D shapes and objects including geometric primitives and CAD models.
Item 44: The method of any previous item, wherein annotating the 3D virtual representation with the semantic information comprises: identifying elements from the plurality of images, the video, and/or the 3D virtual representation by a semantically trained machine learning model, the semantically trained machine learning model configured to perform semantic or instance segmentation and 3D object detection and localization of each object in an input image.
Item 45: The method of any previous item, wherein the description data further comprises one or more media types, the media types comprising at least one or more of video data, image data, audio data, text data, user interface/display data, and/or sensor data.
Item 46: The method of any previous item, wherein capturing description data further comprises receiving sensor data from one or more environment sensors, the one or more environment sensors comprising at least one of a GPS, an accelerometer, a gyroscope, a barometer, or a microphone.
Item 47: The method of any previous item, wherein the description data is captured by a mobile computing device associated with a user and transmitted to one or more processors of the mobile computing device and/or an external server with or without user interaction.
Item 48: The method of any previous item, further comprising generating, in real-time, the 3D virtual representation by: receiving, at a user device, the description data of the location, transmitting the description data to a server configured to execute a machine learning model to generate the 3D virtual representation of the location, generating, at the server based on the machine learning model and the description data, the 3D virtual representation of the location, and transmitting the 3D virtual representation to the user device.
Item 49: The method of any previous item, further comprising: estimating pose matrices and intrinsics for each image of the plurality of images and/or video by a geometric reconstruction framework configured to triangulate 3D points based on the plurality of images and/or video to estimate both camera poses up to scale and camera intrinsics, and inputting the pose matrices and intrinsics to a machine learning model to accurately predict the 3D virtual representation of the location.
Item 50: The method of any previous item, wherein the geometric reconstruction framework comprises at least one of: structure-from-motion (SFM), multi-view stereo (MVS), or simultaneous localization and mapping (SLAM).

The present disclosure contemplates that the calculations disclosed in the embodiments herein may be performed in a number of ways, applying the same concepts taught herein, and that such calculations are equivalent to the embodiments disclosed.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, computer programs, a machine readable medium, and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and subcombinations of the disclosed features and/or combinations and subcombinations of further features noted above. Furthermore, above described advantages are not intended to limit the application of any issued claims to processes and structures accomplishing any or all of the advantages.

Additionally, section headings shall not limit or characterize the invention(s) set out in any claims that may issue from this disclosure. Further, the description of a technology in the “Background” is not to be construed as an admission that technology is prior art to any invention(s) in this disclosure. Neither is the “Summary” to be considered as a characterization of the invention(s) set forth in issued claims. Furthermore, any reference to this disclosure in general or use of the word “invention” in the singular is not intended to imply any limitation on the scope of the claims set forth below. Multiple inventions may be set forth according to the limitations of the multiple claims issuing from this disclosure, and such claims accordingly define the invention(s), and their equivalents, that are protected thereby.

What is claimed is:

1. A non-transitory machine-readable medium storing instructions which, when executed by at least one programmable processor, cause the at least one programmable processor to perform operations comprising:
generating a user interface that comprises an augmented reality (AR) overlay on top of a live camera feed that facilitates positioning guidance information for a user controlling the camera feed in real-time for a scene at a location being scanned;
providing a guide with the AR overlay that moves through the scene at the location during scanning such that the user can follow the guide, and conformance to the guide can be tracked during the scanning to determine if a scanning motion by the user is within requirements, and such that a cognitive load on the user required to obtain a scan is reduced because the user is following the guide, wherein real-time feedback is provided to the user via the guide depending on a user adherence or lack of conformance to guide movements;
capturing description data of the location, the description data being generated via the camera and the user interface, the description data comprising a plurality of images and/or video of the location in the live camera feed;
recording image frames from the plurality of images and/or video being collected from the camera, but not the AR overlay, such that a resulting three dimensional (3D) virtual representation of the location is generated from the image frames from the camera, and the AR overlay is used to guide the user with the positioning guidance information, but is not needed after capture is complete; and
annotating the 3D virtual representation of the location with spatially localized metadata associated with elements within the location, and semantic information of the elements within the location, the 3D virtual representation being editable by the user to allow modifications to the spatially localized metadata.

2. The medium of claim 1, wherein the guide comprises a moving marker including one or more of a dot, a ball, or a cartoon, and indicates a trajectory, the moving marker and the trajectory configured to cause the user to move the camera throughout the scene at the location.

3. The medium of claim 1, wherein the guide comprises a series of tiles configured to cause the user to follow motions indicated by the series of tiles with the camera throughout the scene at the location.

4. The medium of claim 1, wherein the guide is configured to follow a pre-planned route through the scene at the location.

5. The medium of claim 1, wherein the guide is configured to follow a route through the scene at the location determined in real-time during the scan.

6. The medium of claim 1, wherein the guide causes rotational and translational motion by the user.

7. The medium of claim 1, wherein the guide causes the user to scan areas of the scene at the location directly above and directly below the user.

8. The medium of claim 1, the operations further comprising, prior to providing the guide with the AR overlay that moves through the scene at the location, causing the AR overlay to use the user interface to make the user indicate a location of a floor, wall, and/or ceiling in the camera feed, and then providing the guide with the AR overlay that moves through the scene at the location based on the location of the floor, wall, and/or ceiling.

9. The medium of claim 1, the operations further comprising, automatically detecting a location of a floor, wall, and/or ceiling in the camera feed, and providing the guide with the AR overlay that moves through the scene at the location based on the location of the floor, wall, and/or ceiling.

10. The medium of claim 1, the operations further comprising providing a bounding box with the AR overlay configured to be manipulated by the user via the user interface to indicate the location of one or more of a floor, a wall, a ceiling, and/or an object in the scene at the location, and providing the guide with the AR overlay that moves through the scene at the location based on the bounding box.

11. The medium of claim 1, wherein the guide comprises a real-time feedback indicator that shows an affirmative state if a user's position and/or motion is within allowed thresholds, or correction information if the user's position and/or motion breaches the allowed thresholds during the scan.

12. The medium of claim 1, wherein the AR overlay further comprises:
a mini map showing where a user is located in the scene at the location relative to a guided location;
a speedometer showing a user's scan speed with the camera relative to minimum and/or maximum scan speed thresholds, and/or an associated warning;
an indicator that informs the user whether illumination at the location is sufficient for the scan, and/or an associated warning; and/or
horizontal and/or vertical plane indicators.

13. The medium of claim 1, the operations further comprising:
generating, in real-time, via a machine learning model and/or a geometric model, the 3D virtual representation of the location and elements therein, the machine learning model and/or the geometric model being configured to receive the plurality of images and/or video, along with pose matrices, as inputs, and predict geometry of the location and the elements therein to form the 3D virtual representation.

14. The medium of claim 13, wherein generating the 3D virtual representation comprises:
encoding each image of the plurality of images and/or video with the machine learning model;
adjusting, based on the encoded images of the plurality of images, an intrinsics matrix associated with the camera;
using the intrinsics matrix and pose matrices to back-project the encoded images into a predefined voxel grid volume; and
providing the voxel grid as input to a neural network to predict a 3D model of the location for each voxel in the voxel grid.

15. The medium of claim 14, wherein the intrinsics matrix represents physical attributes of a camera, the physical attributes comprising: focal length, principal point, and skew.

16. The medium of claim 15, wherein a pose matrix represents a relative or absolute orientation of the camera in a virtual world, the pose matrix comprising 3-degrees-of-freedom rotation of the camera and a 3-degrees-of-freedom position in a virtual representation.

17. The medium of claim 1, wherein annotating the 3D virtual representation with spatially localized metadata comprises spatially localizing the metadata using a geometric estimation model, or manual entry of the metadata via the user interface,
wherein spatially localizing of the metadata comprises: receiving additional images of the location and associating the additional images to the 3D virtual representation of the location;
computing camera poses associated with the additional images with respect to an existing plurality of images and/or video and the 3D virtual representation; and
relocalizing, via the geometric estimation model and the camera poses, the additional images and associating metadata.

18. The medium of claim 1, wherein metadata associated with an element comprises at least one of: geometric properties of the element; material specifications of the element; a condition of the element; receipts related to the element; invoices related to the element; spatial measurements captured through the 3D virtual representation or physically at the location; audio, visual, or natural language notes; or 3D shapes and objects including geometric primitives and CAD models.

19. The medium of claim 1, wherein annotating the 3D virtual representation with the semantic information comprises: identifying elements from the plurality of images, the video, and/or the 3D virtual representation by a semantically trained machine learning model, the semantically trained machine learning model configured to perform semantic or instance segmentation and 3D object detection and localization of each object in an input image.

20. The medium of claim 1, wherein the description data further comprises one or more media types, the media types comprising at least one or more of video data, image data, audio data, text data, user interface/display data, and/or sensor data.

21. The medium of claim 1, wherein capturing description data further comprises receiving sensor data from one or more environment sensors, the one or more environment sensors comprising at least one of a GPS, an accelerometer, a gyroscope, a barometer, or a microphone.

22. The medium of claim 1, wherein the description data is captured by a mobile computing device associated with a user and transmitted to one or more processors of the mobile computing device and/or an external server with or without user interaction.

23. The medium of claim 1, the operations further comprising generating, in real-time, the 3D virtual representation by:
receiving, at a user device, the description data of the location,
transmitting the description data to a server configured to execute a machine learning model to generate the 3D virtual representation of the location,
generating, at the server based on the machine learning model and the description data, the 3D virtual representation of the location, and
transmitting the 3D virtual representation to the user device.

24. The medium of claim 1, the operations further comprising:
estimating pose matrices and intrinsics for each image of the plurality of images and/or video by a geometric reconstruction framework configured to triangulate 3D points based on the plurality of images and/or video to estimate both camera poses up to scale and camera intrinsics, and
inputting the pose matrices and intrinsics to a machine learning model to accurately predict the 3D virtual representation of the location.

25. The medium of claim 24, wherein the geometric reconstruction framework comprises at least one of: structure-from-motion (SFM), multi-view stereo (MVS), or simultaneous localization and mapping (SLAM).
